(19) United States
(12) Patent Application Publication
(10) Pub. No.: US 2018/0361410 A1
(43) Pub. Date: Dec. 20, 2018

(54) CONTAINER WITH PUMP DISPENSER

(71) Applicants: Sun Hong KIM, Anseong-si (KR); Jeong A Choi, Seoul (KR)

(72) Inventors: Sun Hong KIM, Anseong-si (KR); Jeong A Choi, Seoul (KR)

(21) Appl. No.: 16/011,678

(22) Filed: Jun. 19, 2018

(30) Foreign Application Priority Data
Jun. 20, 2017 (KR) 20-2017-0003194

(51) Int. Cl. B05B 11/00; A45D 34/00

(52) U.S. Cl. CPC B05B 11/0097; A45D 34/00; A45D 2200/055; B05B 11/0089; B05B 11/0037; B05B 11/30

(57) ABSTRACT

According to an embodiment of the disclosure, a container with a pump dispenser may comprise an upper part shaped as a cylinder having an opening in a bottom thereof, having a pump formed on a top thereof, and having an upper female thread formed along an inner circumferential portion of a lower portion thereof, the pump having a discharge hose connected thereto, a lower part shaped as a cylinder having an opening in a top thereof, having an upper male thread along an upper portion thereof to be coupled with the upper female thread of the upper part, and having a stepped portion along under a lower portion thereof to allow a packing to rest thereon, the lower part having a curved bottom, and a cap detachably coupled to the lower portion or the upper portion of the lower part.

### CROSS-REFERENCE TO RELATED APPLICATIONS

This patent application claims priority under 35 U.S.C. § 119 to Korean Utility Model Application No. 20-2017-0003194, filed on Jun. 20, 2017, in the Korean Intellectual Property Office, the disclosure of which is incorporated by reference herein in its entirety.

### TECHNICAL FIELD

Embodiments of the disclosure relate to containers, and more specifically, to bottles with a pump dispenser, having an upper part, a lower part, and a cap, which may be separated from each other and assembled in various forms for a diversity of uses and consuming the content without waste.

### DISCUSSION OF RELATED ART

Containers or bottles for containing shampoo, rinse, bodywash, or hair gel or other various types of content may come with a pump dispenser. When the user presses the pump, the content is sucked up and discharged via the discharge hose connected to the pump. Conventional pump-type containers cannot live up to users' demand of fully consuming the content without waste because the discharge hose is not workable enough to completely suck up all the content.

### SUMMARY

According to an embodiment of the disclosure, a container with a pump dispenser may comprise an upper part shaped as a cylinder having an opening in a bottom thereof, having a pump formed on a top thereof, and having an upper female thread formed along an inner circumferential portion of a lower portion thereof, the pump having a discharge hose connected thereto, a lower part shaped as a cylinder having an opening in a top thereof, having an upper male thread along an upper portion thereof to be coupled with the upper female thread of the upper part, and having a stepped portion along under a lower portion thereof to allow a packing to rest thereon, the lower part having a curved bottom, and a cap detachably coupled to the lower portion or the upper portion of the lower part.

The container may further comprise a finishing member configured to cover where the upper part and the lower part meet and to be removed upon separating the upper part and the second part from each other. The finishing member may be configured of a perforated strap or a flat film tape.

The lower part may include a space under the curved bottom. The lower part may have a cap coupling portion formed in the lower portion thereof. The cap coupling portion may be configured of a lower male thread protruded downwards and formed of an elastic synthetic resin configured to fit into the space when pushed up. The lower male thread may have the same diameter as the upper male thread. The cap may have a cap female thread formed along an inner circumferential surface thereof to be coupled with the lower female thread. The cap female thread may be coupled or decoupled to/from the lower male thread or the upper male thread.

The container may further comprise a lower female thread formed along a circumference of the space. The cap coupling portion may be configured of a cap coupling member including an upper portion configured to form a first male thread coupled to the lower female thread of the space and a lower portion configured to form a second male thread coupled to the cap female thread of the cap. The cap female thread of the cap may be detachably coupled to the second male thread of the cap coupling member or the upper male thread of the lower part.

The container may further comprise a first transparent window and a second transparent window formed in the upper part and the lower part, respectively, the first transparent window and the second transparent window formed to be aligned with each other in a vertical direction of the container when the upper part and the lower part are coupled together. The first transparent window and the second transparent window may have at least one upper gradation and at least one lower gradation, respectively. Multiple gripping depressions may be formed in the upper part and the lower part.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 is an exploded perspective view illustrating a container with a pump dispenser according to an embodiment of the disclosure;

FIG. 2 is a perspective view illustrating a container with a pump dispenser according to an embodiment of the disclosure;

FIG. 3 is a cross-sectional view illustrating a container with a pump dispenser according to an embodiment of the disclosure;

FIG. 4 is a cross-sectional view illustrating a finishing member of a container with a pump dispenser according to an embodiment of the disclosure;

FIG. 5 is a cross-sectional view illustrating a finishing member of a container with a pump dispenser according to an embodiment of the disclosure;

FIG. 6 is a view illustrating a cap coupler of a container with a pump dispenser according to an embodiment of the disclosure;

FIG. 7 is a view illustrating an example of using a container with a pump dispenser according to an embodiment of the disclosure;

FIG. 8 is a view illustrating an example in which an upper part and a lower part of a container with a pump dispenser are separated from each other, according to an embodiment of the disclosure;

FIG. 9 is a view illustrating an example of using a lower part of a container with a pump dispenser according to an embodiment of the disclosure; and

FIG. 10 is a view illustrating an example in which an upper part and a lower part are separated from each other in a container with a pump dispenser according to an embodiment of the disclosure.

### DETAILED DESCRIPTION OF EXEMPLARY EMBODIMENTS

Hereinafter, exemplary embodiments of the disclosure will be described in detail with reference to the accompanying drawings. Like reference denotations may be used to refer to like or similar elements throughout the specification and the drawings. The disclosure, however, may be modified in various different ways, and should not be construed as limited to the embodiments set forth herein. As used herein, the singular forms “a,” “an,” and “the” are intended to include the plural forms as well, unless the context clearly indicates otherwise.

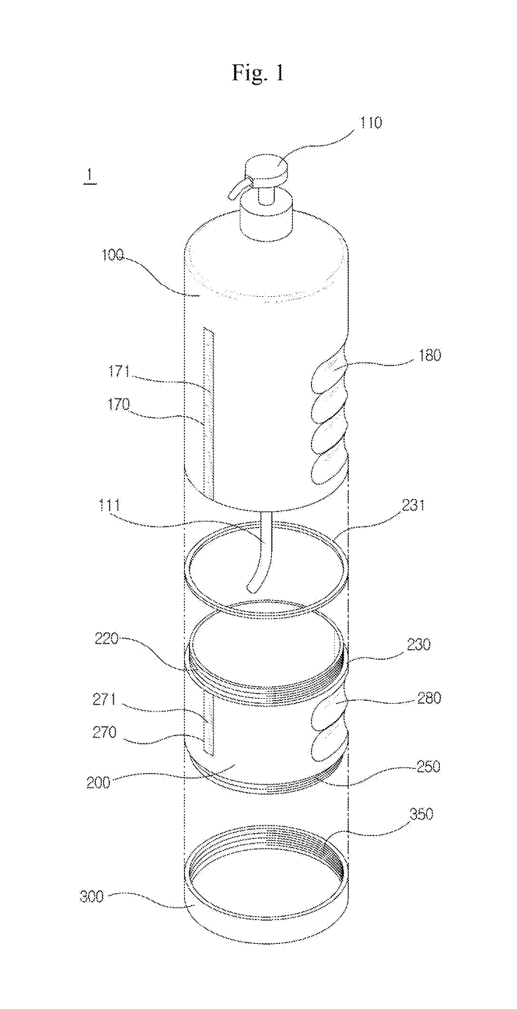

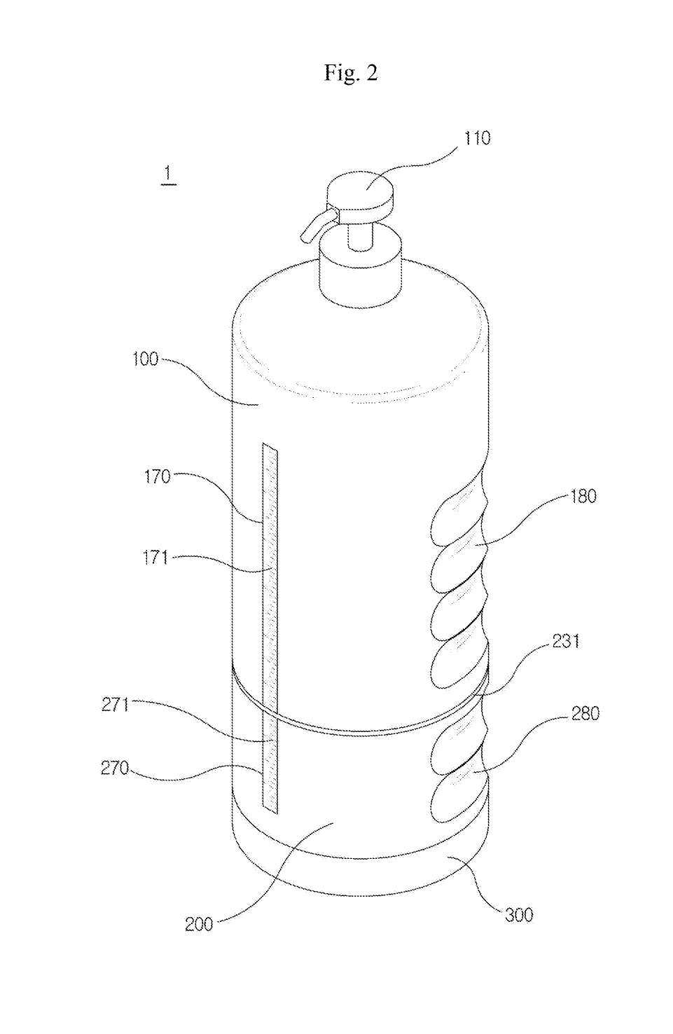

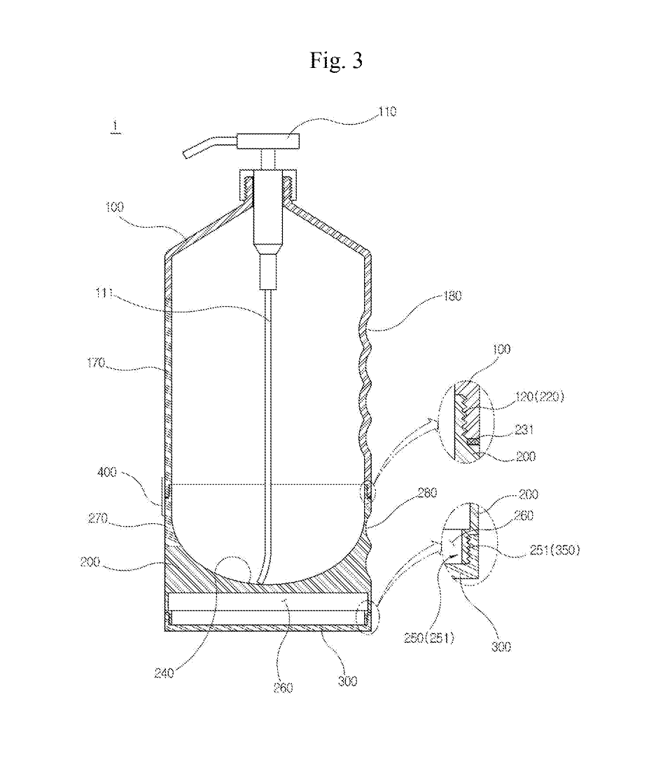

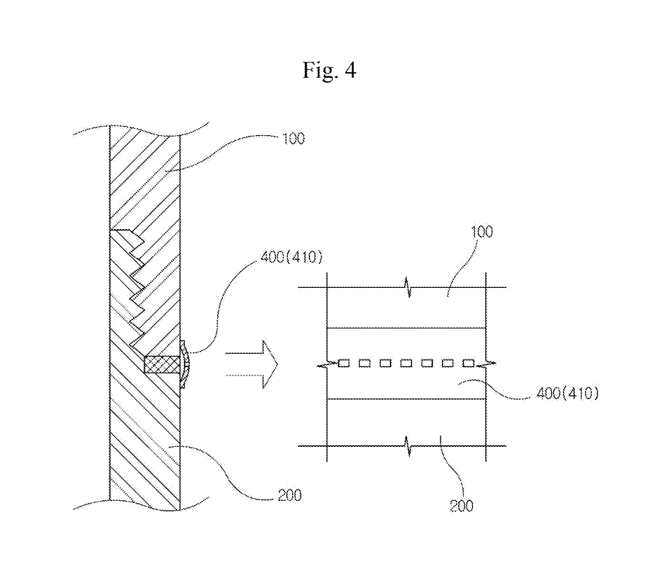

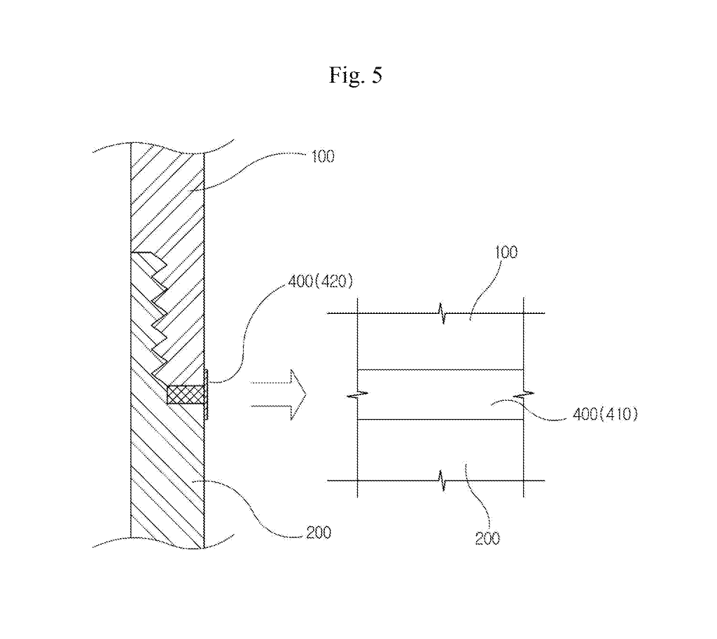

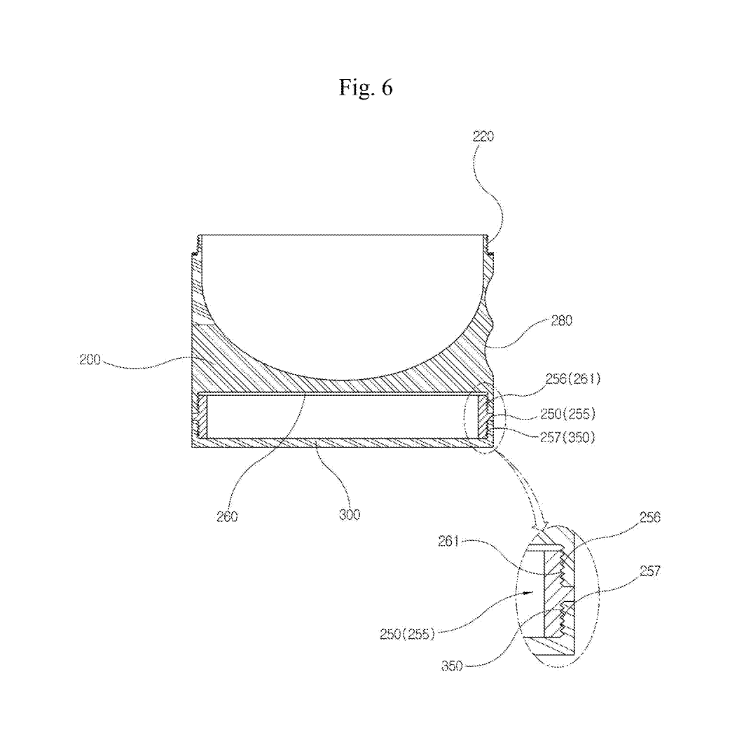

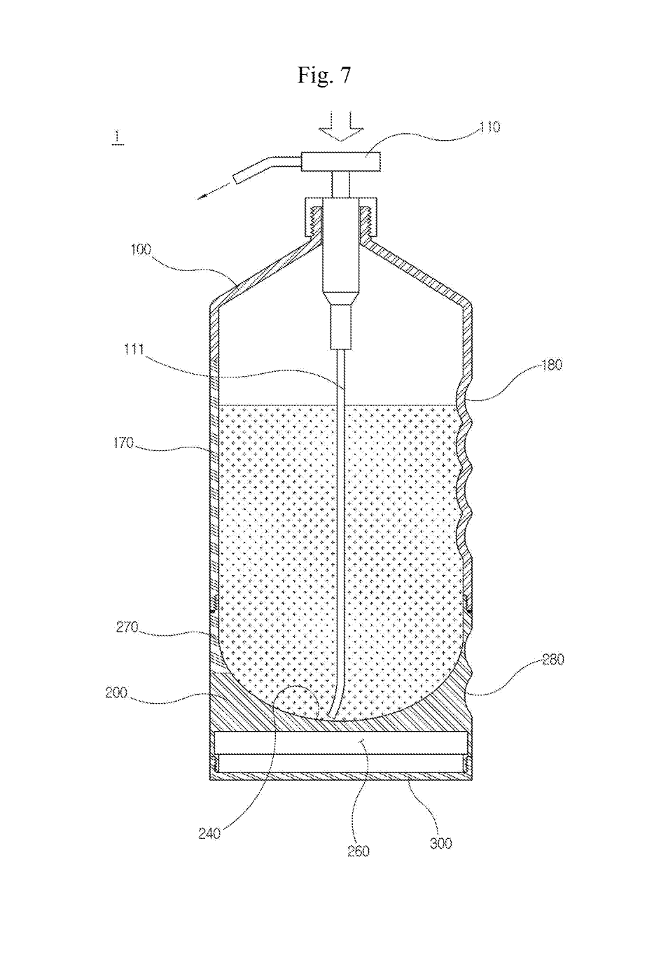

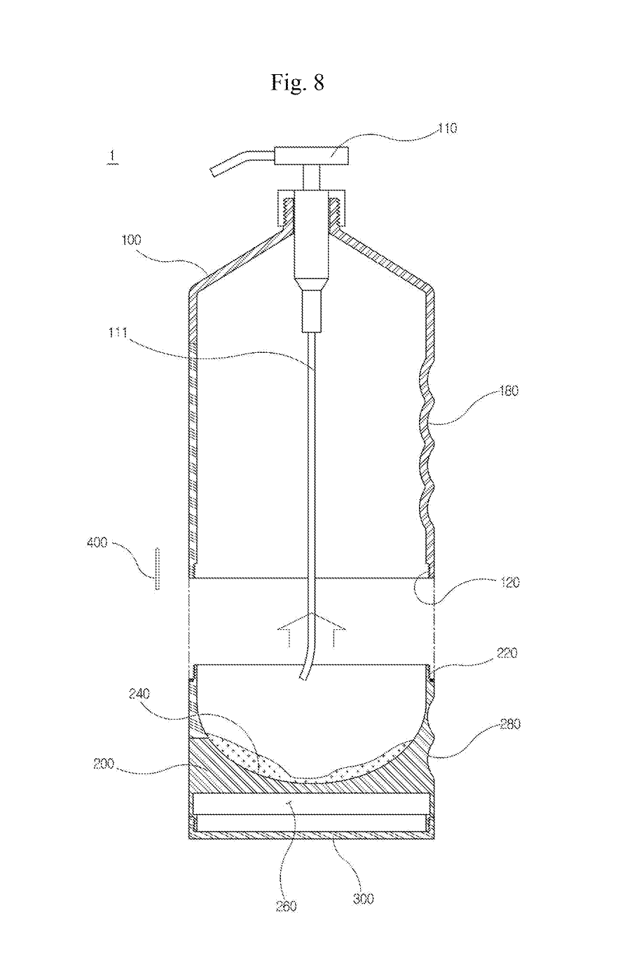

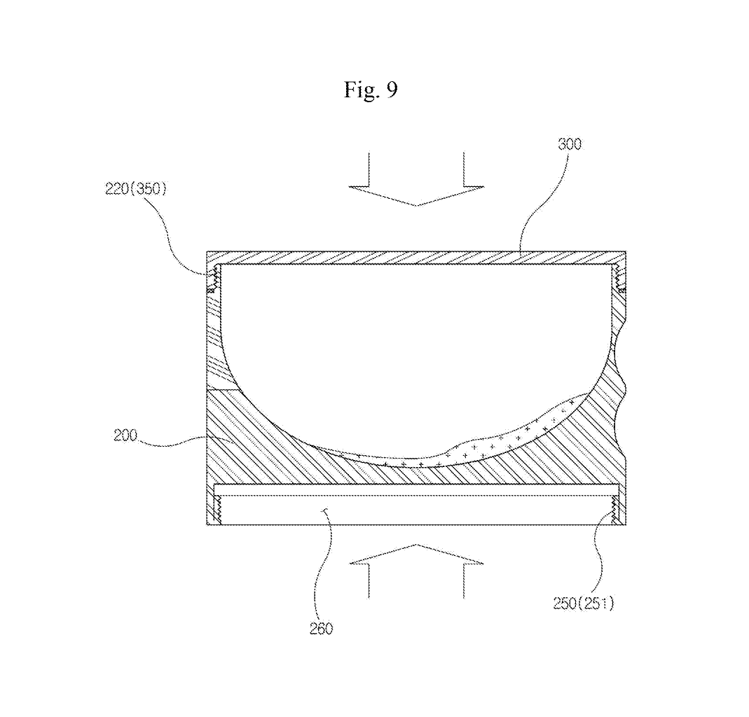

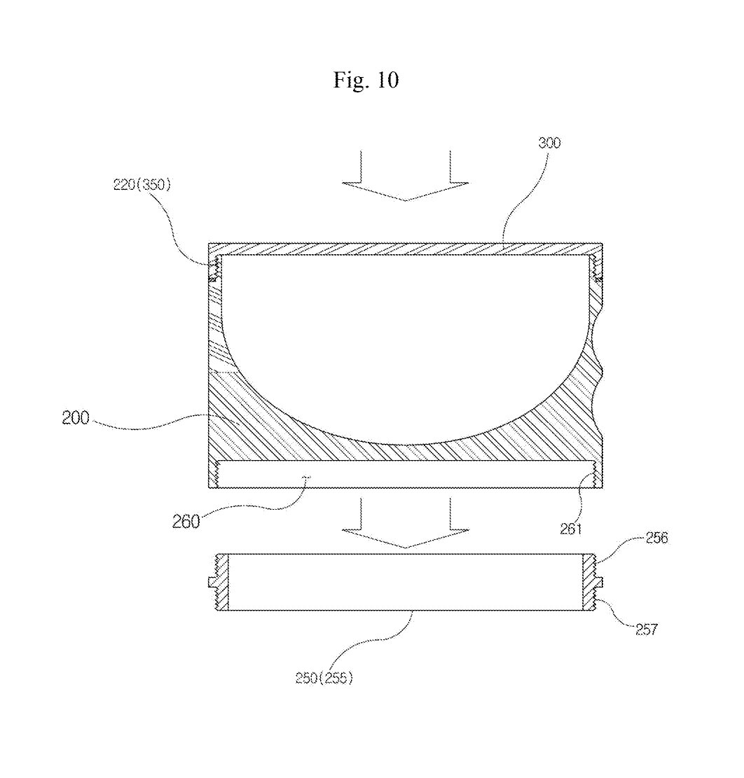

FIG. 1 is an exploded perspective view illustrating a container with a pump dispenser according to an embodiment of the disclosure. FIG. 2 is a perspective view illustrating a container with a pump dispenser according to an embodiment of the disclosure. FIG. 3 is a cross-sectional view illustrating a container with a pump dispenser according to an embodiment of the disclosure. FIG. 4 is a cross-sectional view illustrating a finishing member of a container with a pump dispenser according to an embodiment of the disclosure. FIG. 5 is a cross-sectional view illustrating a finishing member of a container with a pump dispenser according to an embodiment of the disclosure. FIG. 6 is a view illustrating a cap coupler of a container with a pump dispenser according to an embodiment of the disclosure. FIG. 7 is a view illustrating an example of using a container with a pump dispenser according to an embodiment of the disclosure. FIG. 8 is a view illustrating an example in which an upper part and a lower part of a container with a pump dispenser are separated from each other, according to an embodiment of the disclosure. FIG. 9 is a view illustrating an example of using a lower part of a container with a pump dispenser according to an embodiment of the disclosure. FIG. 10 is a view illustrating an example in which an upper part and a lower part are separated from each other in a container with a pump dispenser according to an embodiment of the disclosure.

Referring to FIGS. 1 to 3, a container 1 with a pump dispenser (hereinafter, simply referred to the container 1) includes an upper part 100, a lower part 200, and a cap 300.

The upper part 100 of the container 1 may form an upper structure of the container 1. The upper part 100 of the container 1 may be shaped as an empty cylinder with an opening in the bottom. The upper part 100 of the container 1 may be formed of a synthetic resin.

The upper part 100 may have a pump 110 at the top thereof to discharge content out of the container 1. The pump 110 may have a discharge hose 111 that extends downwards through the bottom opening of the upper part 100.

The pump 110 may be integrally formed with the upper part 100 or the pump 110 may detachably be attached to the upper part 100 via, e.g., screws.

An upper female thread 120 may be formed along a lower, inner circumferential surface of the upper part 110.

The lower part 200 may form a lower structure of the container 1 and may be shaped as an empty cylinder with an opening in the top. The lower part 200 may be shorter in height than the upper part 100. The lower part 200 may be formed of a synthetic resin.

The height of the lower part 200 is not particularly limited. For example, the lower part 200 may be about 5 cm to about 7 cm high for the user to hold it in an easy and convenient way.

An upper male thread 220 may be formed along a top, outer circumferential surface of the lower part 200 to be engaged or coupled with the upper female thread 120.

The lower part 200 may have a stepped portion 230 along the circumference of the bottom of the upper male thread 220 to seat a circular, ring-shaped packing 231 thereon.

The lower part 200 may have a curved bottom 240 that is substantially semi-circular at cross-section view, and the central portion of which is deeper downwards than the rest thereof.

As the upper male thread 220 and the upper female thread 120 are screwed together, the lower part 200 and the upper part 100 are jointed together, forming a single, whole container 1. In this case, the packing 231 is placed on the stepped portion 230, allowing for air-tight seal.

A finishing member 400 may be provided along where the upper part 100 and the lower part 200 are connected with or meet each other to cover the packing 231. The finishing member 400 may reinforce the coupling between the upper part 100 and the lower part 200. The upper part 100 and the lower part 200 may be separated from each other after removing the finishing member 400. The finishing member 400 may be removed by applying an external force thereto.

The finishing member 400 may be configured with various shapes or forms.

For example, referring to FIG. 4, the finishing member 400 may be formed to stick to and surround a lower outer circumference of the upper part 100 and an upper outer circumference of the lower part 200. The finishing member 400 may be a perforated strap 410 formed of a synthetic resin. The finishing member 400, e.g., the perforated strap 410, may be shaped to be curved at cross-sectional view as shown in FIG. 4. The perforated strap 400 may be cut or broken by an external force applied when turning the upper part 100 and the lower part 200 against each other, resultantly allowing the upper part 100 and the lower part 200 from being separated from each other.

As another example, referring to FIG. 5, the finishing member 400 may be formed of a flat, film-type tape 420 that overlappingly attaches to a lower outer circumference of the upper part 100 and an upper outer circumference of the lower part 200. The flat, film-type tape 420 may be detached by the user, so that the user may separate the upper part 100 and the lower part 200 from each other.

The cap 300 has an opening in the top. The cap 300 may detachably be coupled to the bottom of the lower part 200. When the container 1 is used with the upper part 100 and the lower part 200 separated from each other, the cap 300 may be used to open or close the top opening of the lower part 200. The cap 300 may be formed of a synthetic resin.

The lower part 200 may have a space 260 formed under the curved bottom 240.

The lower part 200 may have a cap coupling portion 250 at a lower portion thereof to allow the cap 300 to detachably be attached thereto. For example, the cap coupling portion 250 may fit into the space 260.

The cap coupling portion 250 may be formed in various shapes or forms.

According to an embodiment of the disclosure, the cap coupling portion 250 may have a lower male thread 251 formed along the outer circumference with the same diameter as the upper male thread 220.

The lower male thread 251 may be formed of an elastic or bendable synthetic resin so that, when pushed up by an external force, the cap coupling portion 250 fits into the space 260 and is hidden from the outside.

The cap 300 may have a cap female thread 350 formed along the inner circumference to be screwed with the lower male thread 251.

For example, the cap 300 may be configured to be coupled to the cap coupling portion 250 as the cap female thread 350 and the lower male thread 251 of the lower part 200 are screwed together. The cap 300 may be removed from the bottom of the lower part 200 and may be coupled to the top of the lower part 200 by fitting the cap female thread 350 over the upper male thread 220 of the lower part 200.

As such, the cap 300 may be coupled to either the top or bottom of the lower part 200 depending on uses.

Referring to FIG. 6, the cap coupling portion 250 may be configured of, or include, a cap coupling member 255 to join the lower part 200 and the cap 300 together.

A lower female thread 261 may be formed along the circumference of the space 260 of the lower part 200.

A cap coupling member 255 may include an upper portion to form a first male thread 256 coupled to the lower female thread 261 of the space 260 and a lower portion to form a second male thread 257 coupled to the cap female thread 350 of the cap 300.

For example, the cap coupling member 255 may fit to the lower female thread 261 via the first male thread 256, and the cap 300 may fit to the second male thread 257 of the cap coupling member 255 via the cap female thread 350. As necessary, the cap 300 may be removed from the second male thread 257 and may fit to the upper male thread 220 of the lower part 200 via the cap female thread 350.

The upper part 100 and the lower part 200 may include an upper transparent window 170 and a lower transparent window 270, respectively, to allow the user to see the inside of the container 1. The upper and lower transparent windows 170 and 270 each may be formed of a vertically elongate rectangle. The user may check, e.g., how much the content is left in the container 1. The upper and lower transparent windows 170 and 270 may be formed to be aligned with each other when the upper part 100 and the lower part 200 are in the position of having been joined together.

The upper and lower transparent windows 170 and 270 may be marked with upper gradations 171 and lower gradations 271, respectively.

A row of gripping depressions 180 and a row of gripping depressions 280 may be formed in the outer surfaces of the upper part 100 and the lower part 200, respectively, for the user's easier grip.

Examples of using the container 1 with a pump dispenser are described below in detail.

The container 1 with a pump dispenser may initially be set with the upper part 100, the lower part 200, and the cap 300 assembled together. The upper part 100 and the second part 200 may contain a liquid or other various types of content.

By pressing the pump 110, the content may be sucked up through the discharge hose 111 and discharged out.

The user may check the amount of the content remaining in the container 1 through the upper and lower transparent windows 170 and 270, and at this time, the gradations in the windows 170 and 270 may assist in more accurate checks.

As such, the windows 170 and 270 and the gradations allow the user an easier check on the amount of content remaining in the container 1 and lets the user make up when the content runs short.

Further, the curved bottom 240 of the lower part 200 allows the content to be gathered to the center, facilitating to discharge the content and hence letting the content used up without waste.

The upper part 100 may be removed from the lower part 200 as described above, and this allows for use of the content without leaving in the container 1.

Further, when the continent remains in the container 1, the user may remove the cap 300, which is initially coupled to the lower part 200, from the lower part 200 and fit the cap 300 to the upper part 100. By so doing, the content may be air-tightly kept for long-term use or storage.

When the cap 300 is removed from the bottom of the lower part 200, the lower male thread 251 may be exposed to the outside, which may look ugly. However, as set forth above, the lower male thread 251 is elastic or bendable, and it may be fitted and hidden in the space 260 by pushing up.

As described above in connection with, e.g., FIG. 6, when the cap 300 is removed from the bottom of the lower part 200 and coupled to the top of the lower part 200, the cap coupling member 255 may be exposed downwards and may make it look ugly or untidy. To avoid this, the exposed cap coupling portion 250 may be removed from the lower part 200.

While the disclosure has been shown and described with reference to exemplary embodiments thereof, it will be apparent to those of ordinary skill in the art that various changes in form and detail may be made thereto without departing from the spirit and scope of the disclosure as defined by the following claims.

What is claimed is:

1. A container with a pump dispenser, the container comprising:
an upper part shaped as a cylinder having an opening in a bottom thereof, having a pump formed on a top thereof, and having an upper female thread formed along an inner circumferential portion of a lower portion thereof, the pump having a discharge hose connected thereto;
a lower part shaped as a cylinder having an opening in a top thereof, having an upper male thread along an upper portion thereof to be coupled with the upper female thread of the upper part, and having a stepped portion along under a lower portion thereof to allow a packing to rest thereon, the lower part having a curved bottom; and
a cap detachably coupled to the lower portion or the upper portion of the lower part.

2. The container of claim 1, further comprising a finishing member configured to cover where the upper part and the lower part meet and to be removed upon separating the upper part and the second part from each other, wherein the finishing member is configured of a perforated strap or a flat film tape.

3. The container of claim 1, wherein the lower part includes a space under the curved bottom, the lower part having a cap coupling portion formed in the lower portion thereof, wherein the cap coupling portion is configured of a lower male thread protruded downwards and formed of an elastic synthetic resin configured to fit into the space when pushed up, the lower male thread having the same diameter as the upper male thread, wherein the cap has a cap female thread formed along an inner circumferential surface thereof to be coupled with the lower female thread, and wherein the cap female thread is coupled or decoupled to/from the lower male thread or the upper male thread.

4. The container of claim 3, further comprising a lower female thread formed along a circumference of the space, wherein the cap coupling portion is configured of a cap coupling member including an upper portion configured to form a first male thread coupled to the lower female thread of the space and a lower portion configured to form a second male thread coupled to the cap female thread of the cap, and wherein the cap female thread of the cap is detachably coupled to the second male thread of the cap coupling member or the upper male thread of the lower part.

5. The container of claim 1, further comprising:
a first transparent window and a second transparent window formed in the upper part and the lower part, respectively, the first transparent window and the second transparent window formed to be aligned with each other in a vertical direction of the container when the upper part and the lower part are coupled together, wherein the first transparent window and the second transparent window have at least one upper gradation and at least one lower gradation, respectively, and wherein multiple gripping depressions are formed in the upper part and the lower part.
